(19) United States
(12) Patent Application Publication
(10) Pub. No.: US 2008/0047959 A1
(43) Pub. Date: Feb. 28, 2008

(54) High Frequency Heating Apparatus

(75) Inventors: Hideaki Moriya, Nara (JP); Haruo Suenaga, Osaka (JP); Shinichi Sakai, Nara (JP); Nobuo Shirokawa, Nara (JP); Manabu Kinoshita, Nara (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/577,341

(22) PCT Filed: Oct. 17, 2005
(86) PCT No.: PCT/JP05/19046

§ 371 Date: Apr. 16, 2007

(30) Foreign Application Priority Data
Oct. 18, 2004 (JP) 2004-302598

(51) Int. Cl. H05B 6/74

(52) U.S. Cl. 219/745

(57) ABSTRACT

The invention relates to a high frequency heating apparatus that drives a magnetron such as a microwave, and provides a frequency modulation method of preventing harmonic current occurring due to a high frequency switching operation.

When a driving signal is transmitted in order to drive a first semiconductor switching element (3) and a second semiconductor switching element (4), an inverter operating frequency in the every phase of a commercial power supply is provided as a frequency difference (inclination) of the phase range from 0° to 90° using a triangular wave-forming circuit in an oscillation circuit (16). A modulation waveform for a frequency modulation control is formed, configuring an upper limit clamp, a lower limit clamp, a lower limit value corresponding to the lowest frequency in a frequency modulation-forming circuit (15) on the basis of a commercial power rectifying voltage-dividing waveform after rectification. By combining these optimally, it is possible to prevent the harmonic current from occurring while forming the frequency modulation waveform handling several non-uniformities such as constants of major inverter circuit components or a power supply (Vcc) of a driving control IC unit (14).

### TECHNICAL FIELD

The present invention relates to a control for suppressing generation of harmonic current components in a field of a high frequency heating apparatus such as a microwave oven which performs a dielectric heating process by driving a magnetron.

### BACKGROUND ART

A power supply used in cooking appliances based on high-frequency heating such as a microwave oven used at home has been required to be small in size and light in weight owing to the nature of the cooking appliances. It is desirable that the space for accommodating the power supply is small in order to easily carry it and enlarge a cooking space in the kitchen. For this reason, the microwave oven is becoming smaller and lighter and being manufactured at low cost with employing a switching power supply. As a result, the power supply outputs a current waveform containing lots of harmonic components which are generated by a switching operation of the power supply. In addition, the microwave oven consumes as much as 2000 watts for the sake of shortening the cooking time. As a result, an absolute value of the current is also increased, and it makes difficult to meet a harmonics performance of the power supply. In light of this problem, a control method (improvement measure) for suppressing generation of the harmonic current components has been proposed (for example, see Patent Document 1).

FIG. 12 shows one exemplary diagram of a magnetron-driving power supply for a high frequency heating apparatus (inverter power supply). The magnetron-driving power supply is constituted by a direct-current (DC) power supply 1, a leakage transformer 2, a first semiconductor switching element 3, a first capacitor 5 (snubber capacitor), a second capacitor 6 (resonant capacitor), a third capacitor 7 (smoothing capacitor) a second semiconductor switching element 4, a driving unit 13, a full-wave voltage doubler rectification circuit 11, and a magnetron 12.

The DC power supply 1 applies a DC voltage VDC to a serially connected circuit including the second capacitor 6 and a first coil winding eight of the leakage transformer 2 by performing a full-wave rectification of a commercial power supply. The first semiconductor switching element 3 and the second semiconductor switching element 4 are connected to each other in series and the serially connected circuit including the second capacitor 6 and the first coil winding 8 of the leakage transformer 2 is connected in parallel to the second semiconductor switching element 4.

The first capacitor 5 is connected in parallel to the second semiconductor switching element 4 and serves as the snubber that prevents a surging current (voltage) during a switching process. The high AC voltage output generated in a second coil winding 9 of the leakage transformer 2 is transformed into a high DC voltage in the full-wave voltage doubler rectification circuit 11, and then applied between the anode and cathode of the magnetron 12. A third coil winding 10 of the leakage transformer 2 supplies current to the cathode of the magnetron 12.

The first semiconductor switching element 3 and the second semiconductor switching element 4 are each constituted by an IGBT and a flywheel diode connected in parallel to the IGBT. As a matter of course, the first and second semiconductor switching elements 3 and 4 are not limited to such a kind, but a thyristor, a GTP switching device, and the like can be also used.

The driving unit 13 has an oscillation unit therein for generating driving signals for driving the first semiconductor switching element 3 and the second semiconductor switching element 4. The oscillation unit generates a square wave with a predetermined frequency and transmits the driving signals to the first semiconductor switching element 3 and the second semiconductor switching element 4. Immediately after any one of the first semiconductor switching element 3 and the second semiconductor switching element 4 is turned off, voltage across the both ends of the other semiconductor switching element is high. Consequently, when any one thereof is turned off, a spike-like surge current is produced and thus unnecessary loss and noise are generated. However, by providing a dead time, the turn-off can be delayed until the voltage across the both ends becomes 0 V. Consequently, the unnecessary loss and the noise can be suppressed. As a matter of course, the same operation is similarly applicable to the case of a reverse switching process.

The detailed description of each operation mode of the driving signals generated by the driving-unit 13 will be omitted. However, the characteristics of the circuit configuration shown in FIG. 12 is that the voltage produced by the first semiconductor switching element 3 and the second semiconductor switching element 4 is equal to the DC power supply voltage VDC, that is, 240√2=339 V, even in Europe where the highest voltage 240 V is used at general home. Consequently, even though an emergency situation such as lightning surge or abrupt voltage drop is taken into consideration, the first semiconductor switching element 3 and the second semiconductor switching element 4 can be used as a low-cost device which has a resistance to a 600 V or so (for example, see Patent Document 2).

Next, FIG. 13 shows a resonant property of this kind in an inverter power supply circuit (where an inductance L and a capacitor C constitute the resonant circuit). FIG. 13 is a diagram illustrating a property of current and a working frequency at the time of applying a predetermined voltage to the inverter resonant circuit, and a frequency f0 is a resonant frequency. During the practical inverter operation, a curved line property I1 (solid line) of the current and frequency is used in the frequency range from f1 to f2 which is higher than the frequency f0.

That is, when the resonant frequency is f0, the current I1 has the maximum, and the current I1 reduces as the frequency range increases from F1 to F3. That is because current that flows in the second coil winding of the leakage transformer increases since the current I1 approaches the resonant frequency at the time when the current I1 approaches the low frequency in the frequency range from f1 to f3. Conversely, since the current I1 becomes more distant from the resonant frequency at the time when the current I1 approaches the high frequency, the current of the second coil winding of the leakage transformer decreases. The inverter power supply for driving the magnetron, which is a nonlinear load, obtains a desired output by varying the frequency. For example, it is possible to obtain a continuous output, which is not impossible to obtain in an LC power supply, in the vicinity of f3, f2, and f1 in the case of the power output of 200 W, 600 W, and 1200 W, respectively.

In addition, the alternating current commercial power supply is used. Accordingly, when high voltage is not applied to the vicinity of power supply phases 0° and 180°, the inverter operating frequency is configured to the vicinity of f1, where resonant current increases, in the phases depending on a magnetron property in which a high frequency is not oscillated. In this manner, it is possible to increase a conduction angle in which electrical waves are transmitted by raising a boosting ratio of the applied voltage of the magnetron to the voltage of the commercial power supply. As a result, it is possible to embody a current waveform in which the fundamental wave components are numerous and the harmonics components is small, by changing the inverter operating frequency in every power supply phase. That is, the harmonics performance of the power supply depends on the good or bad control of the frequency modulation.
Patent Document 1: JP-A-2004-0063 84
Patent Document 2: JP-A-2000-058252

### DISCLOSURE OF THE INVENTION

Problem that the Invention is to Solve

However, there is a following drawback or more in the configuration described above.

That is, a constant non-uniformity (coupling coefficient or capacitance value) of major components (leakage transformer or resonant capacitor) constituting an inverter circuit or a non-uniformity (zener voltage) of a zener diode making the power supply Vcc of a control IC unit results in a non-uniformity of an own fundamental inverter resonant circuit or a frequency modulation waveform. Moreover, the non-uniformity causes an inverter operating frequency to vary, and causes a current waveform containing the harmonics components not to meet the harmonics performance of the power supply depending on the extent of non-uniformity.

Means for Solving the Problem

In order to solve the above-described drawback, the invention has been made so as to provide a configuration capable of providing many parameters for configuring a frequency modulation waveform and easily varying the occurrence of a square wave with a predetermined frequency, the square wave produced in an oscillation unit for transmitting a driving signal of a semiconductor switching element.

According to the invention having the above-described configuration, the frequency modulation waveform handling the constant non-uniformity of the major components (leakage transformer or resonant capacitor) constituting the inverter circuit or the non-uniformity of the zener diode making the power supply Vcc of a control IC unit can be formed. In addition, the harmonics performance of the power supply can be satisfied in the any combination condition and the degree of margin for a standard value can be increased.

### ADVANTAGE OF THE INVENTION

With a high frequency heating apparatus according to the invention, an inverter operating frequency in each phase of the commercial power supply is variable, and it is possible to embody a current waveform in which a harmonic component is small, by enlarging the operating frequency in the range from 0° to 90°. It is possible to form a frequency modulation waveform in which the degree of freedom is high by providing an upper limit clamp, a lower limit clamp, and a lower limit value corresponding to the lowest frequency in the frequency modulation waveform determining the inverter operating frequency. Furthermore, it is possible to easily form the frequency modulation waveform for handling an unavoidable constant non-uniformity of major components constituting the high frequency heating apparatus.

### BRIEF DESCRIPTION OF THE DRAWINGS

FIG. 1 is a diagram illustrating a circuit configuration of a high frequency heating apparatus according to a first to fourth embodiments of the invention.

FIG. 2 is a diagram illustrating an oscillation circuit configuration according to the first embodiment of the invention.

FIG. 3 is a graph illustrating a property of a frequency modulation output and an inverter operating frequency according to the first embodiment of the invention.

FIG. 4 is a diagram illustrating a frequency modulation-forming circuit in detail according to a second embodiment of the invention.

FIG. 5 is a diagram illustrating the frequency modulation-forming circuit in detail according to the second embodiment of the invention.

FIGS. 6(a) and 6(b) are graphs illustrating frequency modulation waveforms according to the second embodiment of the invention.

FIG. 7 is a diagram illustrating the frequency modulation-forming circuit in detail according to a third embodiment of the invention.

FIG. 8 is a diagram illustrating the frequency modulation-forming circuit in detail according to the third embodiment of the invention.

FIGS. 9(a) and 9(b) are graphs illustrating the frequency modulation waveforms according to the third embodiment of the invention.

FIG. 10 is a diagram illustrating the frequency modulation-forming circuit in detail according to a fourth embodiment of the invention.

FIG. 11 is a graph illustrating the frequency modulation-forming circuit according to the fourth embodiment of the invention.

FIG. 12 is a diagram illustrating a circuit configuration of the known magnetron-driving high frequency heating apparatus (inverter power supply).

FIG. 13 is a graph illustrating a property of current and a working frequency at the time of applying a predetermined voltage to the inverter resonant circuit.

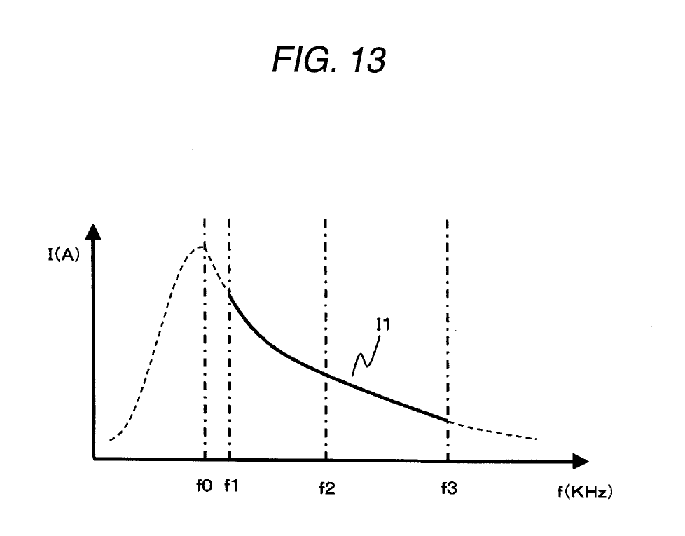

### DESCRIPTION OF REFERENCE NUMERALS AND SIGNS

1: DC POWER SUPPLY

2: LEAKAGE TRANSFORMER

3: FIRST SEMICONDUCTOR SWITCHING ELEMENT (SWITCHING ELEMENT)

4: SECOND SEMICONDUCTOR SWITCHING ELEMENT (SWITCHING ELEMENT)

5: FIRST CAPACITOR

6: SECOND CAPACITOR

7: THIRD CAPACITOR

11: FULL-WAVE VOLTAGE DOUBLER RECTIFCATION CIRCUIT

12: MAGNETRON

14: DRIVING CONTROL IC UNIT

15: FREQUENCY MODULATION-FORMING CIRCUIT

16: OSCILLATION CIRCUIT

17: DEAD TIME-FORMING CIRCUIT

18: SWITCHING ELEMENT-DRIVING CIRCUIT

19: CONSTANT INPUT CONTROL CIRCUIT

155, 156, 157: RESISTOR

158, 159: DIODE

161, 162: RESISTOR (SERIES RESISTOR)

### BEST MODE FOR CARRYING OUT THE INVENTION

According to a first aspect of the invention, a high frequency heating apparatus drives a magnetron by allowing a semiconductor switching element to perform a high frequency switching operation using a commercial power supply, in which the frequency of the high frequency switching operation is variable so that the frequency ascends in the phase range of the power supply from 0° to 90° and from 180° to 270° and descends in the phase range of the power supply from 90° to 180° and from 270° to 360°; and the difference in the operating frequencies between the ascending and descending periods is large.

According to a second aspect of the invention, in the high frequency heating apparatus according to the first aspect of the invention, the frequency of the high frequency switching operation is easily variable by varying a parallel combined resistance value of series resistors.

According to a third aspect of the invention, in the high frequency heating apparatus according to the first aspect of the invention, the variation in the frequency of the high frequency switching operation can be represented as the shape pf a frequency modulation waveform; and wherein the frequency modulation waveform is formed on the basis of a rectification waveform of the commercial power supply and has an upper limit clamp.

According to a fourth aspect of the invention, in the high frequency heating apparatus according to the first aspect of the invention, the variation in the frequency of the high frequency switching operation can be represented as the shape of the frequency modulation waveform; and wherein the frequency modulation waveform is formed on the basis of a rectification waveform of the commercial power supply and has a lower limit clamp.

According to a fifth aspect of the invention, in The high frequency heating apparatus according to the first aspect of the invention, the variation in the frequency of the high frequency switching operation can be represented as the shape of the frequency modulation waveform; and wherein the frequency modulation waveform is formed on the basis of the rectification waveform of the commercial power supply and has a lower limit value corresponding to the restriction of the lowest frequency.

According to a sixth aspect of the invention, in the high frequency heating apparatus according to the first aspect of the invention, the variation in the frequency of the high frequency switching operation can be represented as the shape of the frequency modulation waveform; and wherein the frequency modulation waveform is formed on the basis of the rectification waveform of the commercial power supply and has an upper limit clamp, a lower limit clamp, a lower limit value corresponding to the restriction of the lowest frequency.

According to a seventh aspect of the invention, in the high frequency heating apparatus according to the sixth aspect of the invention, the difference between the upper limit clamp and the lower limit clamp is as small as possible and the shape of the frequency modulation waveform is nearly flat.

According to an eighth aspect of the invention, in the high frequency heating apparatus according to the third or sixth aspect of the invention, the upper limit clamp is uniquely determined as a predetermined fixed value (upper limit value) independent from a variation in voltage values of the commercial power supply.

According to a ninth aspect of the invention, in the high frequency heating apparatus according to the third or sixth aspect of the invention, the upper limit clamp is uniquely determined as a value that undergoes a small variation through a resistor or a diode from a predetermined value independent from a variation in voltage values of the commercial power supply.

According to a tenth aspect of the invention, in the high frequency heating apparatus according to the third or sixth aspect of the invention, the upper limit clamp is determined as a reference value (upper limit value) that varies depending on a variation in voltage values of the commercial power supply.

According to an eleventh aspect of the invention, in the high frequency heating apparatus according to the third or sixth aspect of the invention, the upper limit clamp is determined as a value that undergoes a small variation through a resistor or a diode from a predetermined value that varies depending on a variation in voltage values of the commercial power supply.

According to a twelfth aspect of the invention, in the high frequency heating apparatus according to the fourth or sixth aspect of the invention, the lower limit clamp is uniquely determined as a fixed value (lower limit value) independent from a variation in voltage values of the commercial power supply.

According to a thirteenth aspect of the invention, in the high frequency heating apparatus according to the fourth or sixth aspect of the invention, the lower limit clamp is uniquely determined as a value that undergoes a small variation through a resistor or a diode from a predetermined value independent from a variation in voltage values of the commercial power supply.

According to a fourteenth aspect of the invention, in the high frequency heating apparatus according to the fourth or sixth aspect of the invention, the lower limit clamp is determined as a reference value (lower limit value) that varies depending on a variation in voltage values of the commercial power supply.

According to a fifteenth aspect of the invention, in the high frequency heating apparatus according to the fourth or sixth aspect of the invention, the lower limit clamp is determined as a value that undergoes a small variation through a resistor or a diode from a predetermined value varied depending on a variation in voltage values of the commercial power supply.

According to a sixteenth aspect of the invention, in the high frequency heating apparatus according to the fourth or sixth aspect of the invention, the lower limit value corresponding to the restriction of the lowest frequency is uniquely determined as a predetermined fixed value (lower limit value) independent from a variation in voltage values of the commercial power supply.

According to a seventeenth aspect of the invention, in the high frequency heating apparatus according to the fifth or sixth aspect of the invention, the lower limit value corresponding to the restriction of the lowest frequency is uniquely determined as a predetermined fixed value (lower limit value) that varies depending on a variation in voltage values of the commercial power supply.

In above-described configuration, even under the condition that several non-uniformities such as the constant non-uniformity of the major components constituting the inverter circuit or the non-uniformity of the zener diode making the power supply (Vcc) of a control IC unit, the frequency modulation waveform capable of handling the drawbacks can be formed. In addition, the harmonics performance of the power supply can be satisfied in the any combination condition and the degree of margin for a standard value can be increased.

Hereinafter, embodiments of the invention will be described with reference to drawings. The invention is not limited to the embodiments.

### First Embodiment

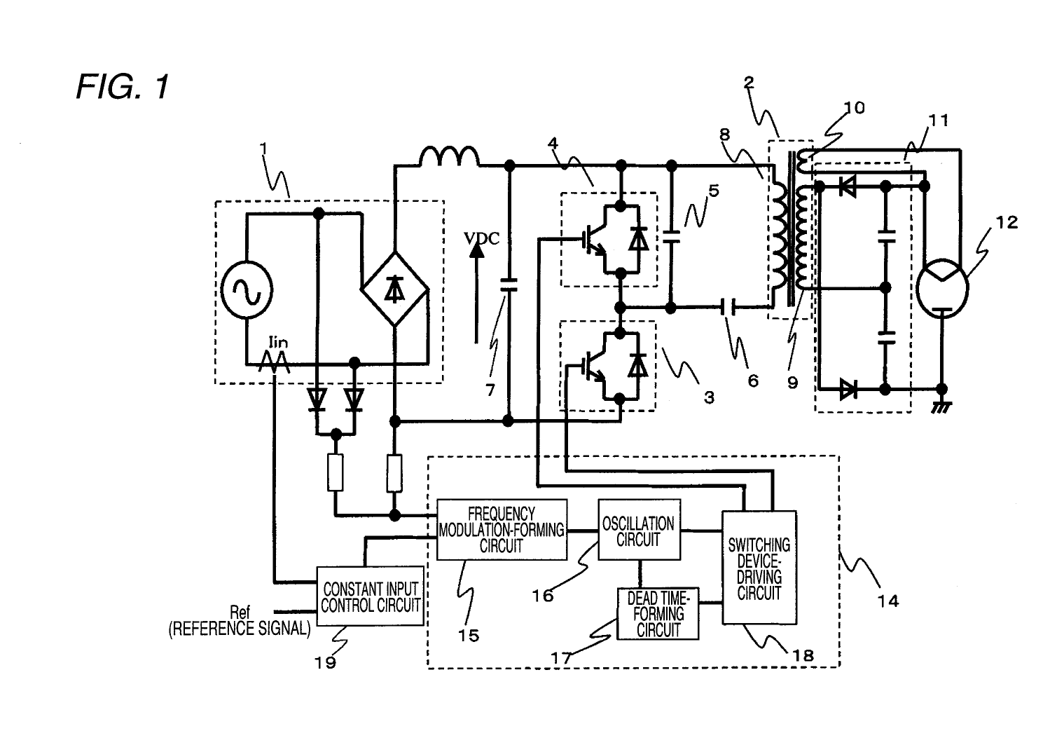

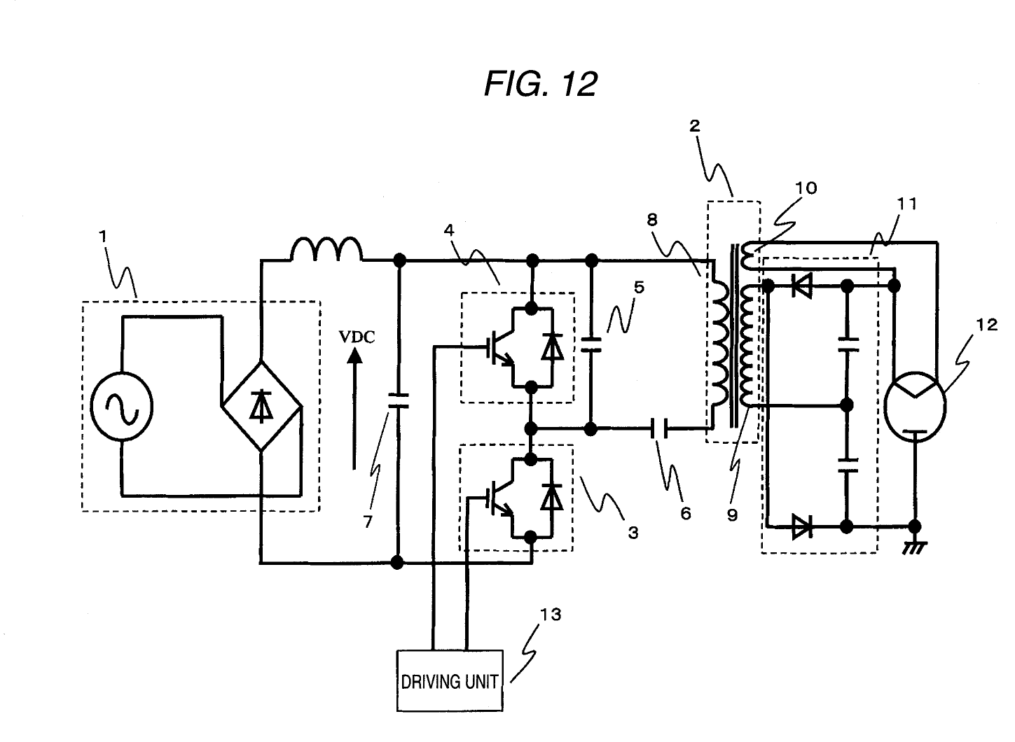

FIG. 1 is a diagram illustrating a circuit configuration for driving a magnetron according to the invention. A DC power supply 1, a leakage transformer 2, a first semiconductor switching element 3, a second semiconductor switching element 4, a first capacitor 5, a second capacitor 6, a third capacitor 7, a driving control IC unit 14, a full-wave voltage doubler rectifcation circuit 11, and a magnetron 12 constitute the overall circuit. The description of the overall circuit configuration will be omitted since it is the same as that shown in FIG. 12.

In the driving control IC unit 14 for driving the semiconductor switching elements 3 and 4, a frequency modulation-forming circuit 15 forms a frequency modulation waveform using a resistance divided waveform on the basis of the voltage of a commercial power supply. The frequency modulation-forming circuit 15 performs a feedback control receiving signals from a constant input control circuit 19 so as to obtain the desired input (200 w or 600 w) described above.

Next, on the basis of the signals obtained from the frequency modulation-forming circuit 15, an oscillation circuit 16 determines a practical operating frequency and a dead time-forming circuit 17 determines a desired dead time. Finally, a square wave formed by the switching device-driving circuit 18 is transmitted to the gates of the first semiconductor switching element 3 and the second semiconductor switching element 4.

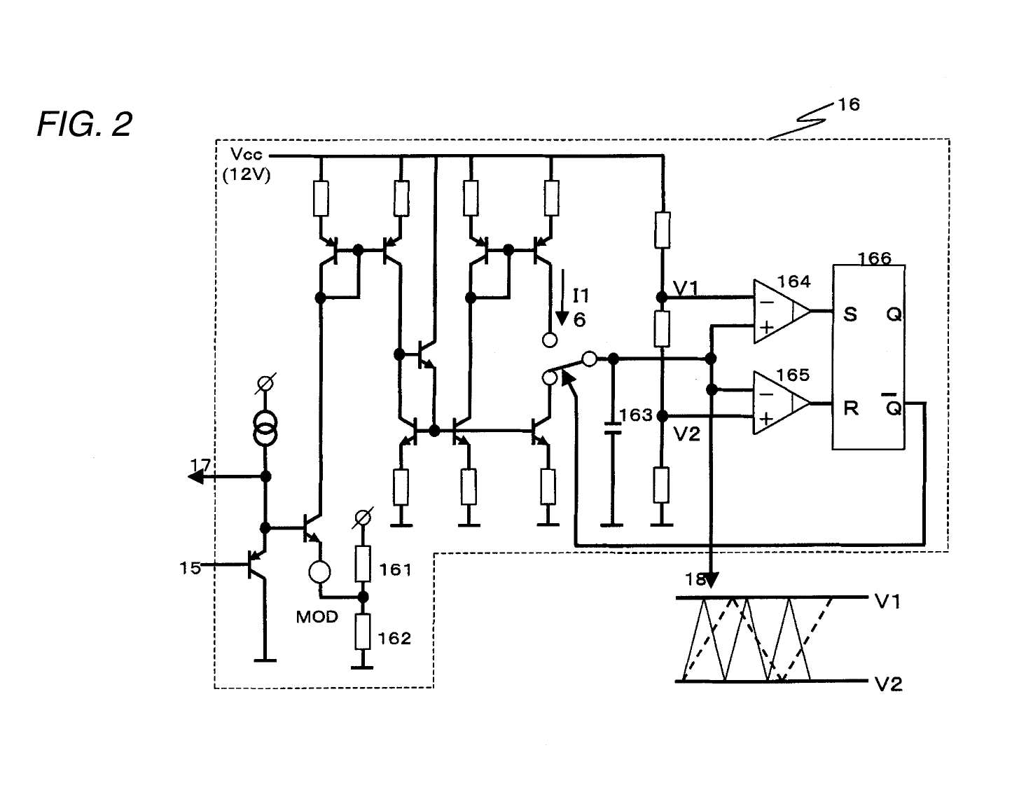

FIG. 2 shows the configuration of an oscillation circuit 16 in detail. The output powers of the comparators 164 and 165 are inputted to the S terminal and the R terminal of an SR flip-flop 166. The output of the inverted Q terminal of the SR flip-flop 166 forms a charge-discharge circuit of a capacitor 163. When the inverted Q terminal is in the level of Hi, 116 charges and the electric potential of the capacitor 163 increase. The electric potential of the capacitor 163 is outputted to the switching device-driving circuit 18. Sequentially, the electric potential of the (+) terminal of the comparator 164 increases and when the electric potential exceeds V1 of the (−) terminal, the output Hi is applied to the S terminal. Afterward, the inverted Q terminal of the SR flip-flop 166 is in the state of Lo, and thus the electric potential of the capacitor 163 discharges. In addition, when the electric potential of the (−) terminal of the comparator 165 discharges and then decreases below V2 of the electric potential of the (+) terminal, the output Hi is applied to the R terminal. Afterward, the inverted Q terminal of the SR flip-flop 166 becomes in the level of Hi and thus the electric potential of the capacitor 163 increases. By repeating the process, triangular save is carried to the switching device-driving circuit 18.

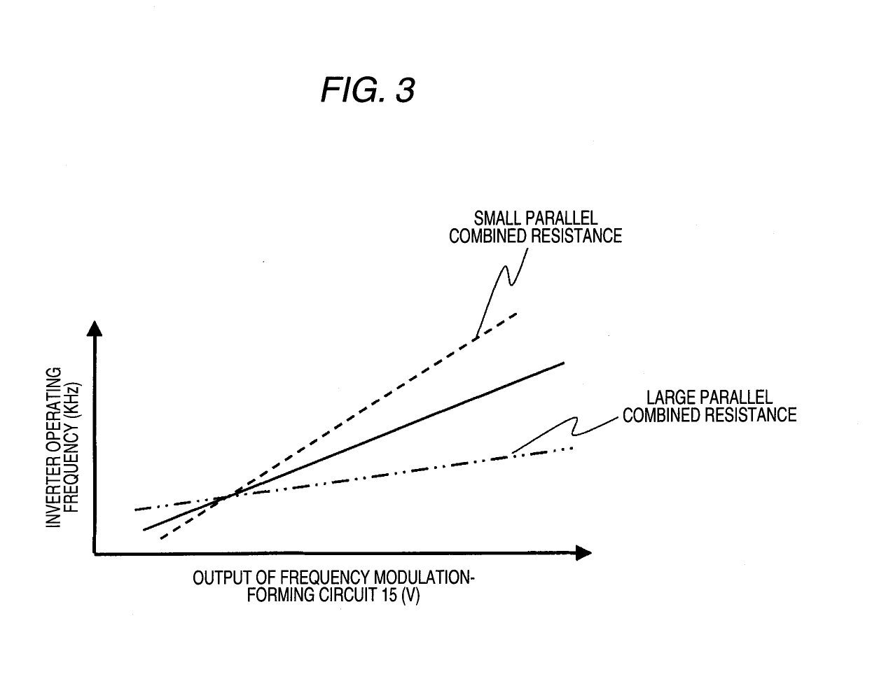

As a matter of course, on the basis of the signal coming from the frequency modulation-forming circuit 15, the charging current 116 of the capacitor 163 is determined by parallel combined resistance of the resistors 161 and 162 which exist in an MOD terminal shown in FIG. 2. That is, the volume of I16 determines the inclination of the triangular wave, that is, the inverter operating frequency. FIG. 3 is a graph illustrating a relationship between the output of the frequency modulation-forming circuit 15 and the inverter operating frequency configured by the resistors 161 and 162. As shown in FIG. 3, the smaller the parallel combined resistance value is, the sharper the inclination for the output variation of the frequency modulation-forming circuit 15 is. Conversely, the larger the value is, the gentler the inclination is. That is, the inverter operating frequency outputted by the frequency modulation-forming circuit 15 can be easily adjusted in accordance with the configuration of the resistors 161 and 162. In addition, in order to prevent the harmonics from occurring, it is important to enlarge the operating frequency of the power supply phase in the range from 0° to 90° as much as possible (Aspects 1 and 2)

### Second Embodiment

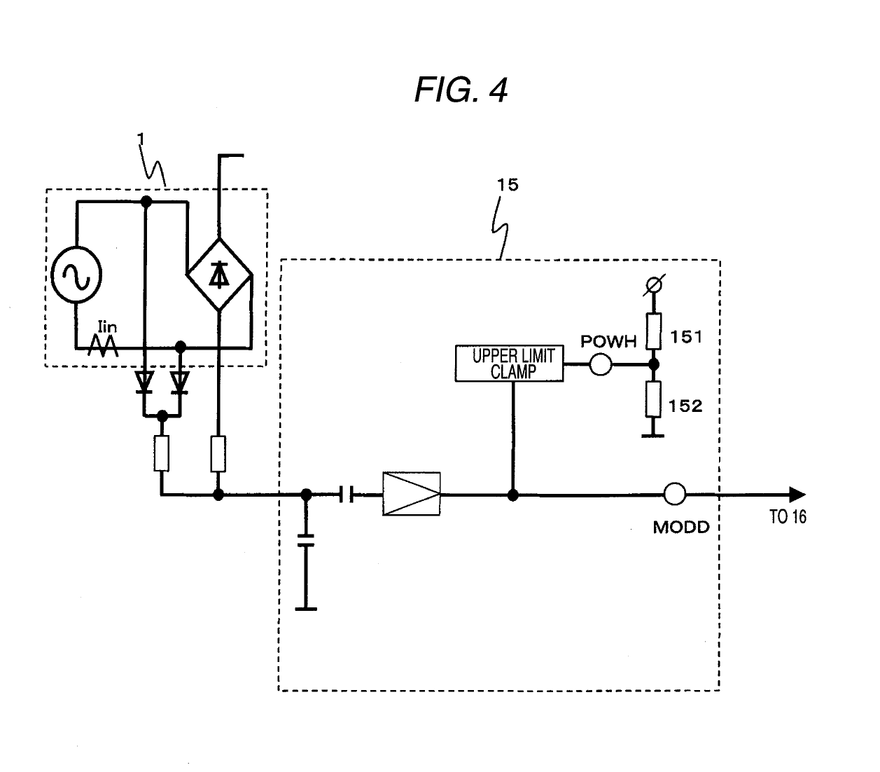

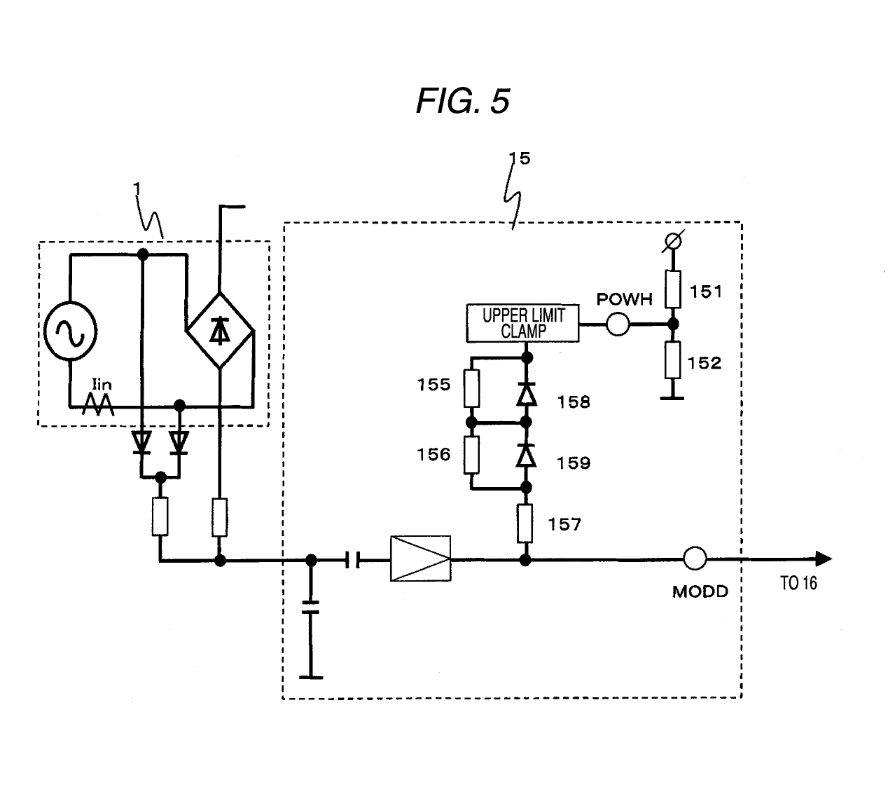

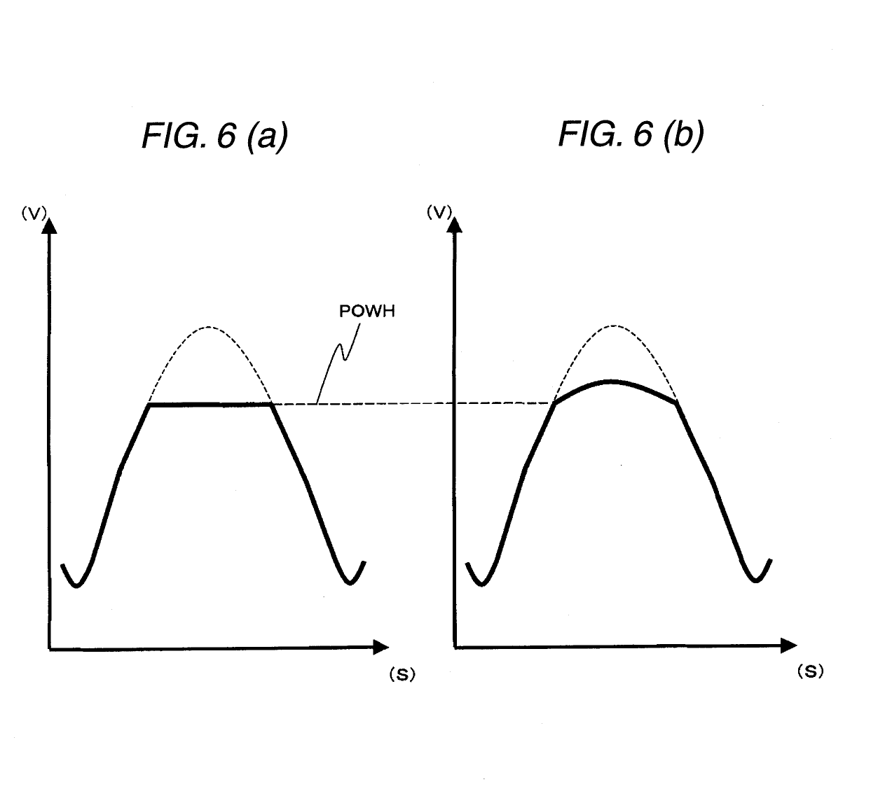

FIG. 4 is an exemplary diagram illustrating the frequency modulation-forming circuit 15 in detail shown in FIG. 1. The fixed voltage obtained in the resistors 151 and 152 becomes the upper limit on the basis of the voltage dividing waveform after the commercial power supply is rectified (Aspects 3 and 8). FIG. 6(a) shows the frequency modulation waveform in this time. On the basis of the commercial power rectifying voltage-dividing waveform indicated by the dashed line, the upper limit value is given as indicated by the solid line. Next, when diodes 158 and 159, and resistors 155, 156, and 157 are provided to an upper clamp shown in FIG. 5, the frequency modulation waveform can be formed as a curved line with some variation from reference voltage given in the resistors 151 and 152, not the fixed value (Aspect 9). FIG. 6(b) shows the curved line indicated by the solid line. In addition, in order to determine the upper limit as a variable value not a fixed value, an increase or decrease is possible on the basis of the voltage information of the commercial power supply (Aspects 10 and 11). In this manner, the optimal frequency modulation waveform can be formed in order to prevent the harmonics component from occurring even in the voltage of each power supply.

### Third Embodiment

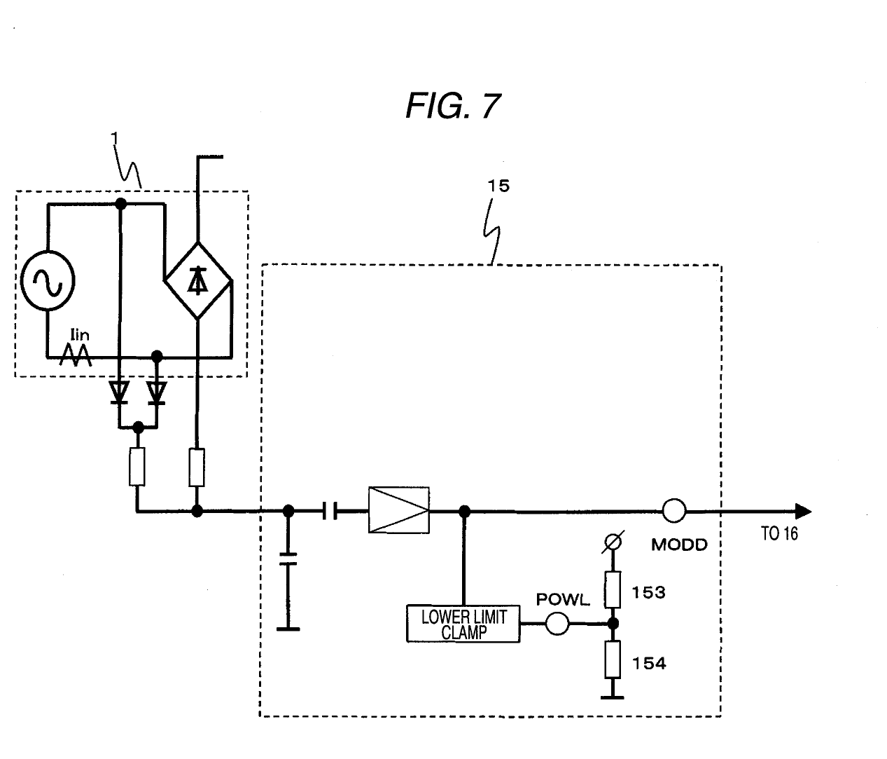

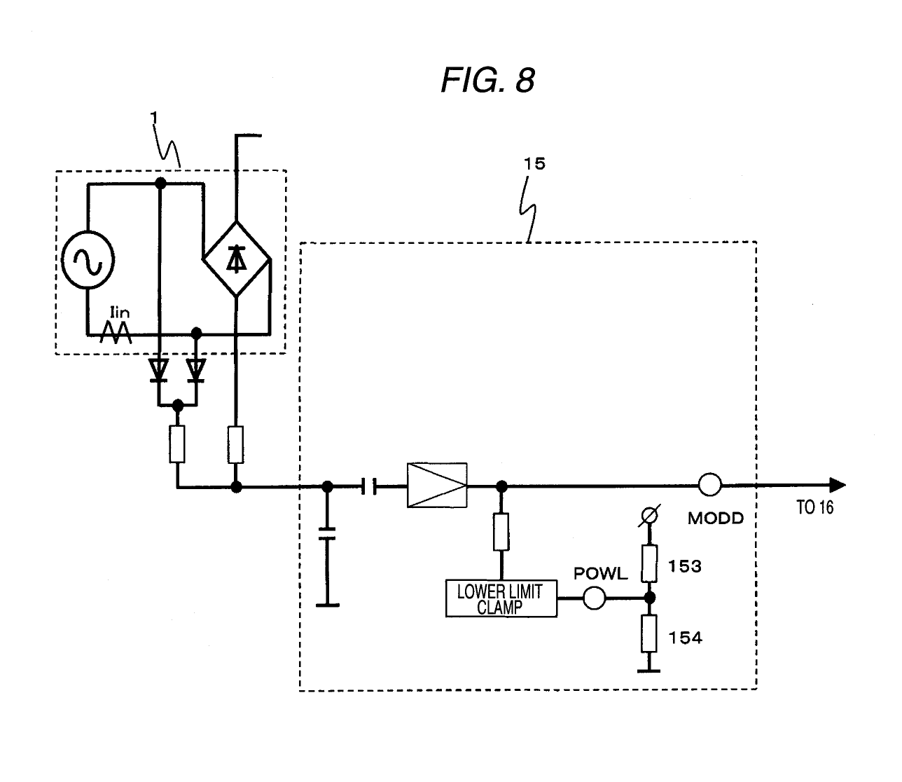

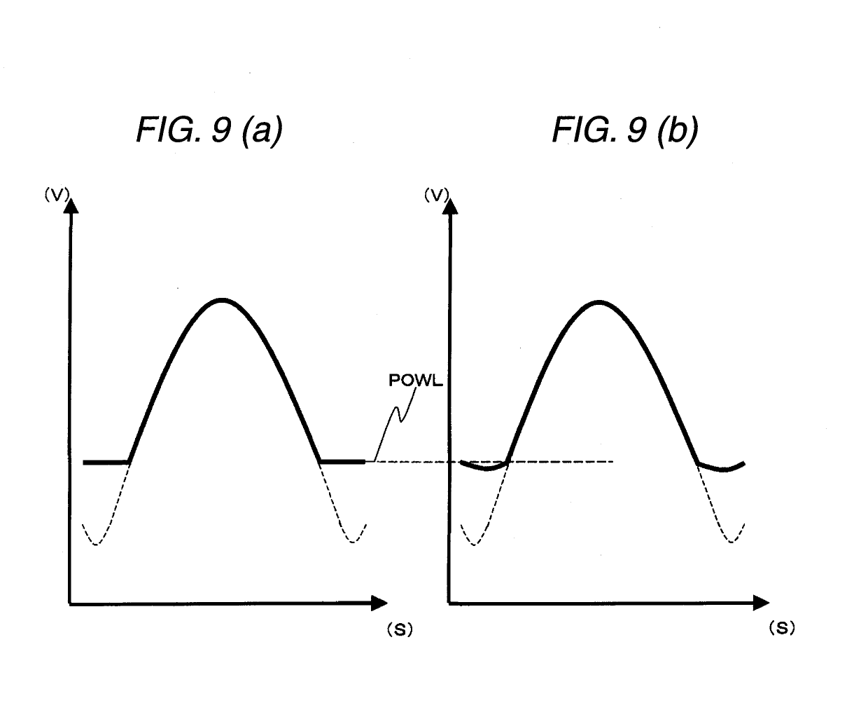

FIG. 7 is an exemplary diagram illustrating the frequency modulation-forming circuit 15 shown in FIG. 1. The lower limit value is restricted to the fixed voltage given from the resistors 153 and 154 on the basis of a voltage-dividing waveform after rectifying the commercial power supply. In this case, the lower limit clamp means the lower limit value corresponding to the lowest frequency restriction (Aspects 4, 5, 12, and 16). FIG. 9(a) shows the frequency modulation waveform in this case, and the lower limit (lower limit corresponding to the lowest frequency) indicated by the solid line is denoted on the basis of the commercial power rectifying voltage-dividing waveform indicated by the dashed line. Next, when a resistor is provided to the lower limit clamp shown in FIG. 8, the frequency modulation waveform can be formed as a curved line with some variation from the reference voltage obtained in the resistors 153 and 154 not a fixed value (Aspect 13). FIG. 9(b) shows the curved line indicated by the solid line. In addition, in order to determine the lower limit as a variable value not the fixed value of the lower limit clamp or the lowest frequency restriction, an increase or decrease is possible on the basis of the voltage information of the commercial power supply (Aspects 14, 15, and 17). In this configuration, the optimal frequency modulation waveform can be formed in order to prevent the harmonics component from occurring even in the voltage of each power supply.

### Fourth Embodiment

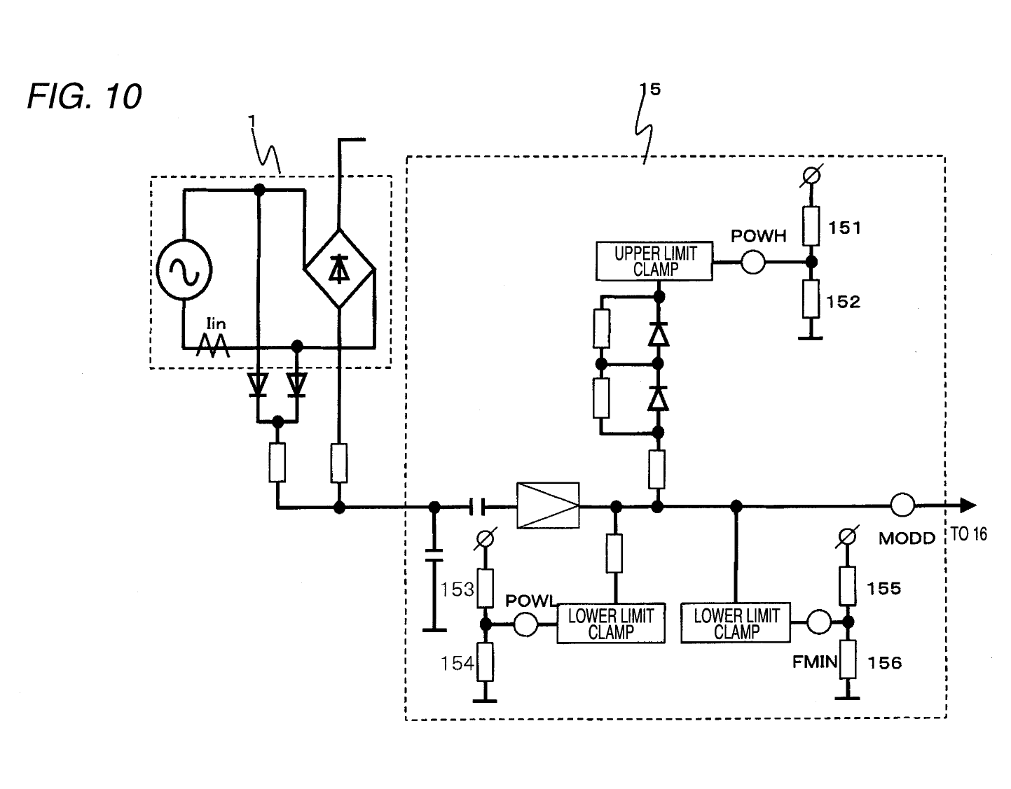

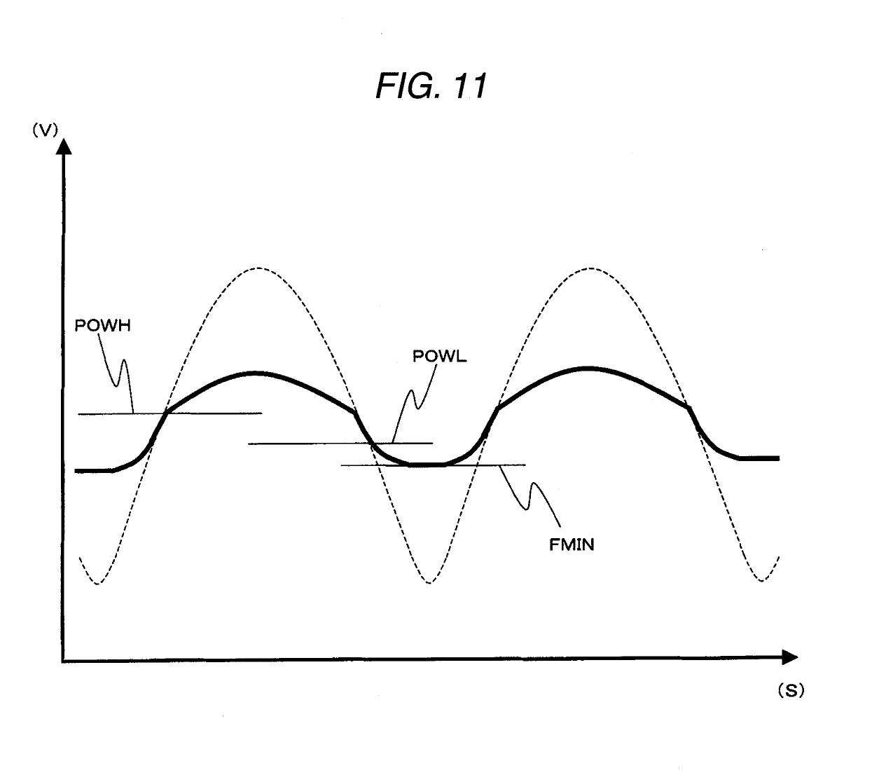

FIG. 10 is a diagram illustrating combined means for forming frequency modulation waveform in the frequency modulation-forming circuit 15 according to the second and third embodiments. By including the upper limit clamp, the lower limit clamp, the lower limit value corresponding to the lowest frequency restriction to the frequency modulation waveform, a waveform indicated by the solid line shown in FIG. 11 can be obtained, several frequency modulation is possible at each point of the voltage phase of the power supply from the relationship of the inverter operating frequency described in the first embodiment (Aspect 6). As a matter of course, in order not to fix the modulation means and to allow the voltage to be variable, an increase or decrease is possible on the basis of the voltage information of the commercial power supply. In the configuration, it is possible to form the optimal frequency modulation waveform to prevent the harmonic components from occurring in each voltage of the power supply. In addition, when the control agent parameter increases, the frequency modulation waveform which undergoes small variation can be effectively formed in spite of several non-uniformities, evaluating an optimal solution by a quality stability design method which is an improved method of the Taguchi Methods and its own science solution method of our company, and preventing the harmonics of the power supply more rapidly. The important point is that the difference between the upper limit clamp and the lower limit clamp is as small as possible and the frequency modulation waveform is nearly flat (Aspect 7).

The invention has been described in detail in reference to the specific embodiments, but may be modified in various forms without departing from the gist of the invention by a person skilled in the related art. The application is based on Japanese Patent Application No. 2004-302598 filed on Oct. 18, 2004, which is incorporated by reference.

### INDUSTRIAL APPLICABILITY

As describe above, the high frequency heating apparatus according to the invention can embody the current waveform in which a harmonic component is small by allowing the inverter operating frequency in each phase of a commercial power supply to be variable, and enlarging the difference in the operating frequencies of the phase range from 0° to 90°. Consequently, the high frequency heating apparatus can be applied to every kind of an apparatus using an inverter.

1. A high frequency heating apparatus which drives a magnetron by allowing a semiconductor switching element to perform a high frequency switching operation using a commercial power supply,
wherein the frequency of the high frequency switching operation is variable so that the frequency ascends in the phase range of the power supply from 0° to 90° and from 180° to 270° and descends in the phase range of the power supply from 90° to 180° and from 270° to 360°; and
wherein the difference in the operating frequencies between the ascending and descending periods is large.

2. The high frequency heating apparatus according to claim 1, wherein the frequency of the high frequency switching operation is easily variable by varying a parallel combined resistance value of series resistors.

3. The high frequency heating apparatus according to claim 1, wherein the variation in the frequency of the high frequency switching operation can be represented as the shape pf a frequency modulation waveform; and
wherein the frequency modulation waveform is formed on the basis of a rectification waveform of the commercial power supply and has an upper limit clamp.

4. The high frequency heating apparatus according to claim 1, wherein the variation in the frequency of the high frequency switching operation can be represented as the shape of the frequency modulation waveform; and
wherein the frequency modulation waveform is formed on the basis of a rectification waveform of the commercial power supply and has a lower limit clamp.

5. The high frequency heating apparatus according to claim 1, wherein the variation in the frequency of the high frequency switching operation can be represented as the shape of the frequency modulation waveform; and
wherein the frequency modulation waveform is formed on the basis of the rectification waveform of the commercial power supply and has a lower limit value corresponding to the restriction of the lowest frequency.

6. The high frequency heating apparatus according to claim 1, wherein the variation in the frequency of the high frequency switching operation can be represented as the shape of the frequency modulation waveform; and
wherein the frequency modulation waveform is formed on the basis of the rectification waveform of the commercial power supply and has an upper limit clamp, a lower limit clamp, a lower limit value corresponding to the restriction of the lowest frequency.

7. The high frequency heating apparatus according to claim 6, wherein the difference between the upper limit clamp and the lower limit clamp is as small as possible and the shape of the frequency modulation waveform is nearly flat.

8. The high frequency heating apparatus according to claim 3, wherein the upper limit clamp is uniquely determined as a predetermined fixed value independent from a variation in voltage values of the commercial power supply.

9. The high frequency heating apparatus according to claim 3, wherein the upper limit clamp is uniquely determined as a value that undergoes a small variation through a resistor or a diode from a predetermined value independent from a variation in voltage values of the commercial power supply.

10. The high frequency heating apparatus according to claim 3, wherein the upper limit clamp is determined as a reference value that varies depending on a variation in voltage values of the commercial power supply.

11. The high frequency heating apparatus according to claim 3, wherein the upper limit clamp is determined as a value that undergoes a small variation through a resistor or a diode from a predetermined value that varies depending on a variation in voltage values of the commercial power supply.

12. The high frequency heating apparatus according to claim 4, wherein the lower limit clamp is uniquely determined as a fixed value independent from a variation in voltage values of the commercial power supply.

13. The high frequency heating apparatus according to claim 4, wherein the lower limit clamp is uniquely determined as a value that undergoes a small variation through a resistor or a diode from a predetermined value independent from a variation in voltage values of the commercial power supply.

14. The high frequency heating apparatus according to claim 4, wherein the lower limit clamp is determined as a reference value that varies depending on a variation in voltage values of the commercial power supply.

15. The high frequency heating apparatus according to claim 4, wherein the lower limit clamp is determined as a value that undergoes a small variation through a resistor or a diode from a predetermined value varied depending on a variation in voltage values of the commercial power supply.

16. The high frequency heating apparatus according to claim 5, wherein the lower limit value corresponding to the restriction of the lowest frequency is uniquely determined as a predetermined fixed value independent from a variation in voltage values of the commercial power supply.

17. The high frequency heating apparatus according to claim 5, wherein the lower limit value corresponding to the restriction of the lowest frequency is uniquely determined as a predetermined fixed value that varies depending on a variation in voltage values of the commercial power supply.
